(19) United States
(12) Patent Application Publication
(10) Pub. No.: US 2004/0222875 A1
(43) Pub. Date: Nov. 11, 2004

(54) Blade type fuse holder and contact used in the same

(76) Inventor: Takeshi Izumi, Ebina (JP)

Correspondence Address: JoAnn Dilloway, Barley Snyder, 126 East King Street, Lancaster, PA, 17602-2893, US

(21) Appl. No.: 10/868,326

(22) Filed: Jun. 15, 2004

Related U.S. Application Data
(62) Division of application No. 10/396,901, filed on Mar. 25, 2003.

(30) Foreign Application Priority Data
Mar. 25, 2002 (JP) 2002-83771

(51) Int. Cl. H01H 85/02

(52) U.S. Cl. 337/198

(57) ABSTRACT

A blade fuse holder configured to have a reduced overall height. The blade fuse holder has a housing that accommodates a pair of contacts. The pair of contacts each has a pair of opposing contact arms that extend from a base part. The pair of opposing contact arms each has a contact projection in a position corresponding to a cut-out formed in the base part so that a distal end of a blade fuse that has been inserted between the pair of opposing contact arms is received in the cut-out.

### BACKGROUND OF THE INVENTION

The invention relates to a blade fuse holder. More specifically, the invention relates to a blade fuse holder that accomodates a contact and receives a blade fuse that is used, for example, in the electrical wiring of automobiles.

### DESCRIPTION OF THE PRIOR ART

Traditionally, transparent glass tubular fuses are used in electrical wiring. Blade fuses, however, are steadily replacing the use of transparent glass tubular fuses in electrical wiring. The blade fuses are approximately thirty percent lighter, more compact, and have five times higher durability than the transparent glass tubular fuses.

An example of a blade fuse holder is disclosed in Japanese Utility Model Application Kokoku No. S59-3487 and is shown in FIG. 4. Blade fuse holder 100 has a housing 110 into which blades 201 of a blade fuse 200 are inserted downward from above. A pair of contacts 120 is accommodated in the housing 110 so that each of the contacts 120 face each other. Each of the contacts 120 has a flat-plate-form base part 121, a pair of contact arms 122 extending from side parts of the base part 121 and bent inward, and an electrical wire crimping part 123 extending from a rear end (the right side in FIG. 4(A)) of the base part 121. An electrical wire W is crimped in the electrical wire crimping part 123. The contacts 120 are arranged so that a direction of a center line of the contacts 120 is positioned in a direction perpendicular to the insertion direction of the blades 201.

The housing 110 has two box-form parts 111a, 111b connected via a hinge 117. The box-form parts 111a, 111b rotate about the hinge 117. The box-form parts 111a, 111b are anchored to each other by an anchoring projection 118b formed on an upper surface of the box-form part 111b and an anchoring recess 118a formed on an upper surface of the box-form part 111a. A vertical wall 113a is formed on the upper surface of one box-form part 111a, and a vertical wall 113b is formed on the upper surface of the box-form part 111b so that a fuse holder accommodating recess 112 is formed by the two vertical walls 113a, 113b when the box-form parts 111a, 111b are anchored. A pair of opening parts 114 are formed in the bottom part of the fuse holder accommodating recess 112 to allow insertion of the blades 201 of the blade fuse 200. Contact arm accommodating cavities 115 are formed beneath the respective opening parts 114. Crimping part accommodating cavities 116 are formed a direction perpendicular to the blade insertion direction of the respective contact arm accommodating cavities 115.

As shown in FIG. 4(B), when the blade fuse 200 is inserted into the fuse holder accommodating recess 112, the blades 201 pass through the respective opening parts 114. The blades 201 are received between the pair of contact arms 122 of the respective contacts 120 and make contact with the contact arms 122. As a result, the contact 120 on one side and the contact 120 on the other side are electrically connected via the blade fuse 200. A cover (not shown) is then attached to the vertical walls 113a, 113b from above the blade fuse 200.

The conventional blade fuse holder 100 shown in FIG. 4 has a disadvantage in that the base parts 121 between the pairs of contact arms 122 of the respective contacts 120 are formed as flat plates that prohibit the blades 201 from passing therethrough when the blades 201 are inserted through the opening parts 114. Accordingly, when the blades 201 are received between the pair of contact arms 122, lower ends of the blades 201 are separated from the surfaces of the base parts 121 causing the height from the base parts 121 to top parts of the blade fuse 200 to be large. This structure makes it difficult to lower the height of the blade fuse holder 100, including the blade fuse, as a whole.

It is therefore desirable to develop a blade fuse holder and contact wherein a direction of a center line of the contact is disposed in a direction perpendicular to a direction of insertion of a blade fuse and the overall height of the holder, including the blade fuse, is reduced.

### SUMMARY OF THE INVENTION

The invention relates to a blade fuse holder having a housing that accommodates a pair of contacts. The pair of contacts each has a pair of opposing contact arms that extend from a base part. The pair of opposing contact arms each has a contact projection in a position corresponding to a cut-out formed in the base part so that a distal end of a blade fuse that has been inserted between the pair of opposing contact arms is received in the cut-out.

### BRIEF DESCRIPTION OF THE DRAWINGS

FIG. 1 is a partial sectional perspective view of a blade fuse holder;

FIG. 2 is a partial sectional perspective view of a blade fuse holder and a blade fuse during insertion of the blade fuse into the blade fuse holder;

FIG. 3 is a perspective view of a contact; and

FIG. 4 is an example of a conventional blade fuse holder; FIG. 4(A) is a perspective view of the conventional blade fuse holder and contacts; and FIG. 4(B) is a sectional view of the conventional blade fuse holder after a blade fuse has been inserted into the conventional blade fuse holder.

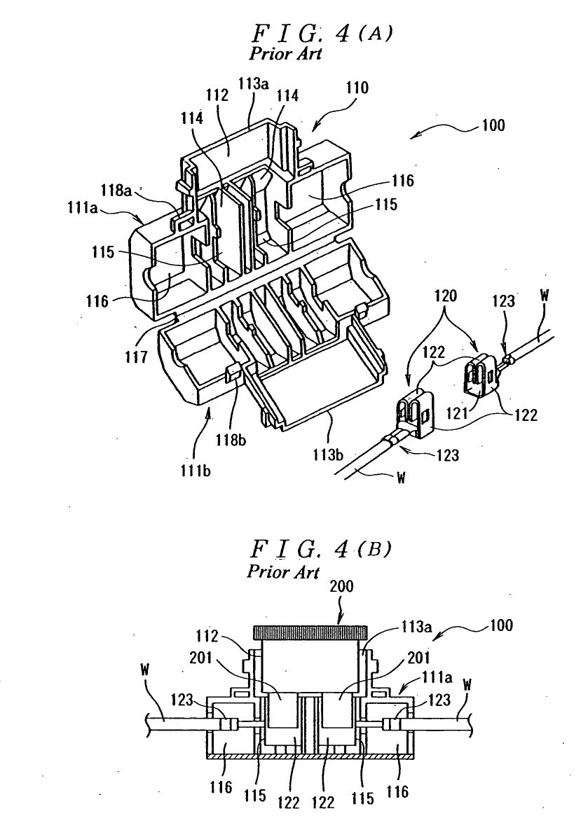

### DETAILED DESCRIPTION OF THE PREFERRED EMBODIMENT

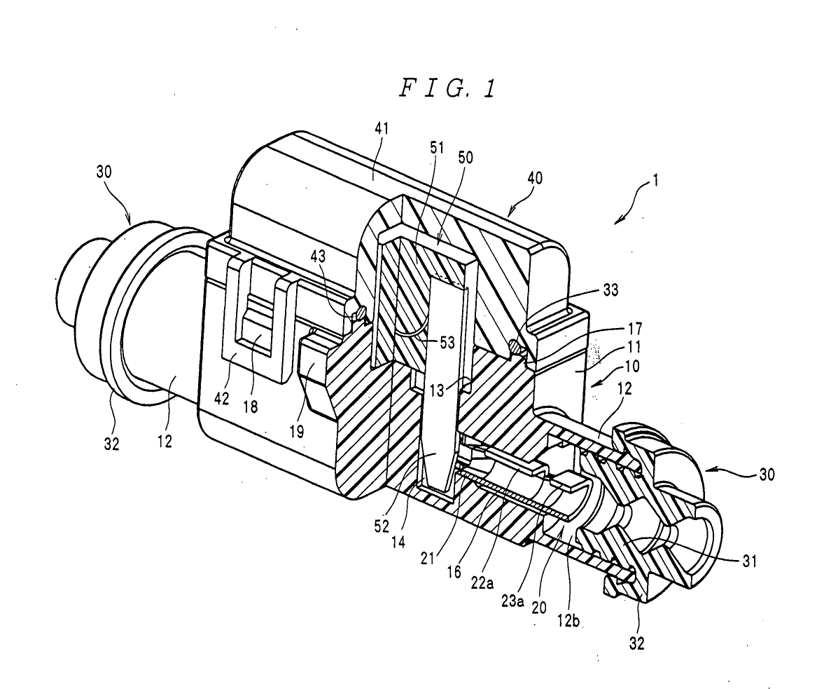

FIG. 1 shows a blade fuse holder 1. The blade fuse holder 1 includes a housing 10, a pair of sealing members 30, and a cover 40. A pair of contacts 20 is accommodated in the housing 10. A blade fuse 50 is received in the housing 10 and engages the contacts 20.

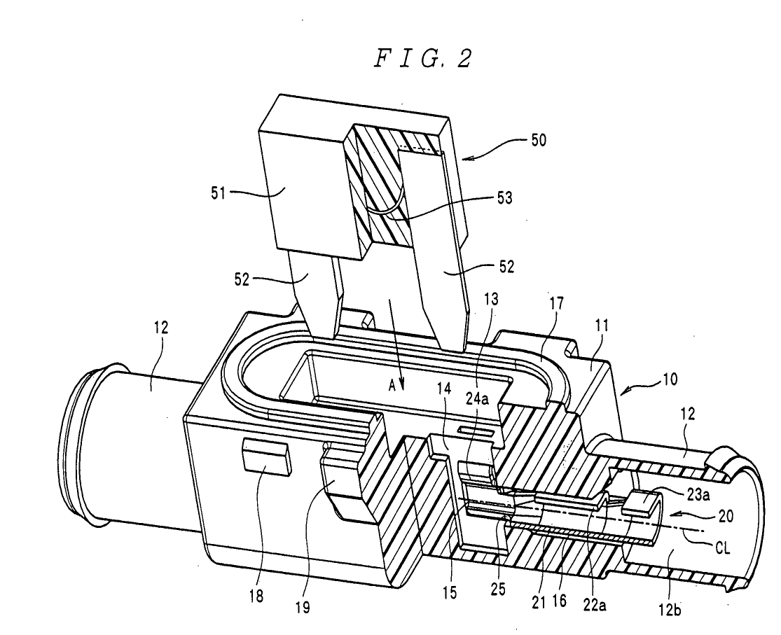

The individual elements of the invention will now be described in greater detail. As best shown in FIG. 2, the blade fuse 50 has a substantially rectangular insulating housing 51. A pair of metal blades 52 is attached to the insulating housing 51 and extends therefrom. A fuse link 53 connects the blades 52.

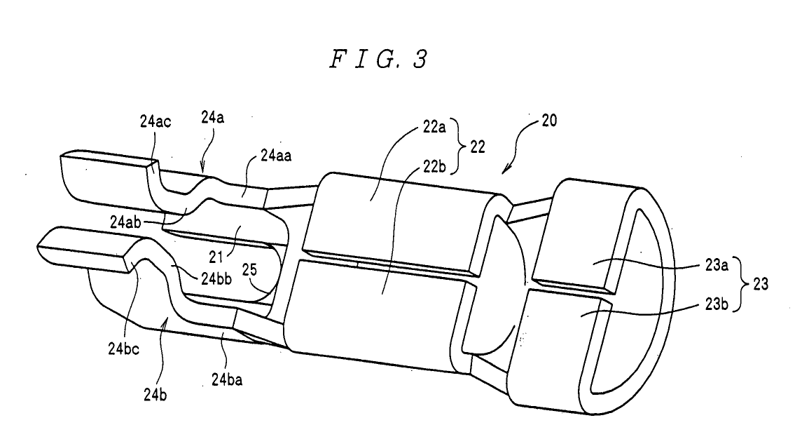

As best shown in FIG. 3, the contacts 20 are formed by stamping and forming a metal plate. Each contact 20 has a flat-plate-form base part 21, a pair of contact arms 24a, 24b, a wire barrel 22, and an insulation barrel 23. The wire barrel 22 is formed in a central portion of the base part 21 with respect to a direction of length. The wire barrel 22 is configured to crimp a core wire of an electrical wire (not shown). The wire barrel is constructed from a pair of core wire crimping parts 22a, 22b. The core wire crimping parts 22a, 22b are bent toward each other from both side portions of the base part 21.

The insulation barrel 23 is formed in a rear end portion of the base part 21 with respect to the direction of length. The insulation barrel 23 is configured to crimp a covering of the electrical wire (not shown). The insulation barrel 23 has a pair of covering crimping parts 23a, 23b. The covering crimping parts 23a, 23b are bent toward each other from both side portions of the base part 21.

The contact arms 24a, 24b extend from both sides of a front end (left end in FIG. 3) of the base part 21 with respect to the direction of length. Each contact arm 24a, 24b has a rising part 24aa, 24ba, respectively, that extends from a side of the base part 21. Contact projections 24ab, 24bb protrude inward and towards each other from upper ends of the rising parts 24aa, 24ba. Introduction guiding parts 24ac, 24bc are bent outward from upper ends of the contact projections 24ab, 24bb. The space between the contact projections 24ab, 24bb may be adjusted in accordance with the thickness of the blades 52. Cut-outs 25 are formed in the base parts 21 between the pairs of contact arms 24a, 24b. The cut-outs 25 are formed in front end edges of the base parts 21 with respect to the direction of length and open on a front end side. The cut-outs may alternatively be formed as holes whose circumferences are closed in an endless configuration.

As shown in FIGS. 1 and 2, the housing 10 has a substantially rectangular housing main body 11 formed by moulding an insulating synthetic resin such as PBT. The housing main body 11 has a fuse accommodating recess 13 formed in an upper surface configured to accommodate the insulating housing 51 of the blade fuse 50. A pair of opening parts 14 are formed in a bottom part of the fuse accommodating recess 13 and are configured to accommodate the blades 52. Contact arm accommodating cavities 15 are formed in substantially central portions of the opening parts 14 with respect to the vertical direction. The contact arm accommodating cavities 15 are configured to accommodate the contact arms 24a, 24b. Wire barrel accommodating passages 16 are formed in a direction perpendicular to a blade insertion direction A and are configured to receive the wire barrels 22. The wire barrel accommodating passages 16 communicate with the contact arm accommodating cavities 15. As best shown in FIG. 2, each of the pair of contacts 20 is accommodated in the housing 10 so that the contacts 20 face each other and so that the direction of a center line CL of the contacts 20 is disposed in the direction that is perpendicular to the blade insertion direction A.

A pair of tubular parts 12 protrude from both end parts of the housing main body 11 in the direction perpendicular to the direction of blade insertion A. As best shown in FIG. 1, sealing member accommodating recesses 12b are formed inside the tubular parts 12. The sealing member accommodating recesses 12b are configured to receive the insulation barrels 23 of the contacts 20.

As shown in FIG. 1, sealing members 30 are disposed between the tubular parts 12 and the electrical wires (not shown) connected to the contacts 20. The sealing members 30 provide a waterproof seal that prevents the invasion of water from the outside. Each of the sealing members 30 has a tubular sealing main body 31 disposed between the tubular part 12 and the electrical wire (not shown). An anchoring part 32 extends to the outside from an outer circumferential part of the sealing main body 31.

As shown in FIGS. 1 and 2, two front-side anchoring projections 18 (only one is shown in FIG. 1) protrude from an upper side of a front surface (front surface in FIG. 1) of the housing main body 11. The front-side anchoring projections 18 are formed to provide a gap in the direction that is perpendicular to the blade insertion direction A. A single rear-side anchoring projection (not shown), which is used to anchor the cover 40, protrudes from the upper side of a rear surface of the housing main body 11. The rear-side anchoring projection (not shown) is formed in the direction perpendicular to the blade insertion direction A and is located between the front-side anchoring projections 18 formed on the front surface of the housing main body 11.

As shown in FIG. 1, the cover 40 has a cover main body 41 formed by moulding an insulating synthetic resin. The cover main body 41 has two front-side latch members 42 (only one is shown in the figures) formed on a lower part of a front surface of the cover main body 41. The front-side latch members 42 are anchored on the front-side anchoring projections 18 of the housing 10. A single rear-side latch member (not shown) is formed on a lower part of a rear surface of the cover main body 41 and is anchored on the rear-side anchoring projection (not shown) of the housing 10. The cover 40 is provided to cover the blade fuse 50. An O-ring 33 is disposed inside an annular recess 43 of the cover 40.

As shown in FIGS. 1 and 2, a projection 19 protrudes from the front surface of the housing main body 11 between the two front-side anchoring projections 18. If the cover 40 is attached to the housing 10 with the front side of the cover 40 corresponding to the rear side of the housing 10, the rear-side latch member formed on the rear surface of the cover 40 contacts the projection 19 formed on the front surface of the housing 10 so that backward attachment of the cover 40 with respect to the forward-rearward direction is prevented.

As shown in FIGS. 1 and 2, a rib 17 is formed around a circumference of the fuse accommodating recess 13 and protrudes from the upper surface of the housing main body 11. An annular recess 43 is formed on an undersurface of the cover 40. The annular recess 43 is formed so that the rib 17 fits into the annular recess 43 when the cover 40 is carried on the housing main body 11. An O-ring 33 is disposed between the rib 17 and the annular recess 43 to prevent the invasion of water therebetween.

Assembly of the blade fuse holder 1 will now be described in greater detail. The contacts 20 are crimped and connected to the end portions of the electrical wires (not shown) that are passed through the sealing members 30. As shown in FIG. 2, the contacts 20 to which the electrical wires (not shown) are crimped are inserted into the housing 10 so that the contact arms 24a, 24b are positioned inside the contact arm accommodating cavities 15, and the wire barrels 22 are positioned inside the wire barrel accommodating passages 16. Walls of the housing 10 thereby restrict vertical movement of the contacts 20. The rear ends of the contact arms 24a, 24b (with respect to the direction of length) are anchored by elastic lances (not shown) formed in the housing 10 to prevent the contacts 20 from slipping out. The sealing main bodies 31 of the sealing members 30 are then positioned inside the tubular parts 12. The sealing members 30 are attached to the tubular parts 12.

Mating of the blade fuse holder 1 and the blade fuse will now be described in greater detail. The blade fuse 50 is inserted into the fuse accommodating recess 13 of the housing 10 in the downward direction from above, i.e., in the direction indicated by arrow A in FIG. 2. As a result, the blades 52 are positioned inside the opening parts 14, as shown in FIG. 1. The introduction guiding parts 24ac, 24bc facilitate insertion of the blades 52 between the contact arms 24a, 24b. The contact projections 24ab, 24bb receive the blades 52 of the blade fuse 50 therebetween and make contact therewith. When the blades 52 are inserted, the lower ends of the blades 52 pass through the cut-outs 25 formed in the base parts 21 between the contact arms 24a, 24b. Accordingly, the height from the base parts 21 of the contacts 20 to the top part of the blade fuse 50 is low, so that the overall height of the blade fuse holder 1 (including the blade fuse 50) may be reduced. When the blades 52 make contact with the contact arms 24a, 24b, the contacts 20 are electrically connected via the blades 52 and fuse link 53 of the blade fuse 50. The amount of contact between the contact projections 24aa, 24bb and the blades 52 is large so that the reliability of the connection is improved.

The cover 40 is attached to the housing 10 from above the blade fuse 50. The front-side latch members 42 and rear-side latch member of the cover 40 are respectively anchored on the front-side anchoring projections 18 and rear-side anchoring projection (not shown) of the housing 10. As a result, the blade fuse 50 is covered and sealed by the O-ring 33 so that the blade fuse 50 is protected from the outside environment.

When the blade fuse 50 is to be removed from the blade fuse holder 1, the front-side latch members 42 and rear-side latch member (not shown) may be respectively removed from the front-side anchoring projections 18 and rear-side anchoring projection (not shown) by the use of a specified tool, or by a manual operation. The blade fuse 50 is then pulled-out of the housing 10.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

1-11. (cancelled).

12. A contact for use in a blade fuse holder, comprising:
a base part having a cut-out for receiving a distal end of a blade fuse; and
a pair of opposing contact arms that extend from the base part, the pair of opposing contact arms substantially converge in a position corresponding to the cut-out.

13. The contact of claim 12, further comprising a wire barrel formed adjacent to the pair of opposing contact arms, the wire barrel having crimping parts for crimping a core wire of an electrical wire.

14. The contact of claim 12, further comprising an insulation barrel, the insulation barrel having crimping arms for crimping a covering of an electrical wire.

15. The contact of claim 12, wherein the pair of opposing guide contact arms have distal ends that diverge to guide the fuse blade between the pair of opposing contact arms.

16. The contact of claim 12, wherein the cut-out is formed on an edge of the base part so that the cut-out has an open side at the edge.

17. The contact of claim 12, wherein the pair of contact arms is formed so that the blade fuse is inserted from a direction perpendicular to a direction of a center line of the contact.

18. The contact of claim 12, wherein the base part is formed as a flat plate.

19. The contact of claim 12, wherein the contact is formed by stamping and forming a single metal plate.

20. The contact of claim 12, wherein the pair of opposing contact arms includes contact projections at the position where the pair of contact arms converge for contacting the blade fuse.

21. A blade fuse holder comprising:
an insulating housing having a pair of contacts, each of the contacts having a base part with a cut-out for receiving a distal end of a blade fuse and a pair of opposing contact arms that extend from the base part, the pair of opposing contact arms substantially converge in a position corresponding to the cut-out.

22. The blade fuse holder of claim 21, wherein each of the contacts includes a wire barrel formed adjacent to the pair of opposing contact arms having crimping parts for crimping a core wire of an electrical wire and an insulation barrel having crimping arms for crimping a covering of an electrical wire.

23. The blade fuse holder of claim 21, wherein the pair of opposing contact arms have distal ends that diverge to guide the fuse blade between the pair of opposing contact arms.

24. The blade fuse holder of claim 21, wherein the cut-out is formed on an edge of the base part so that the cut-out has an open side at the edge.

25. The blade fuse holder of claim 21, wherein the pair of opposing contact arms is formed so that the blade fuse is inserted from a direction perpendicular to a direction of a center line of the contact.

26. The blade fuse holder of claim 21, wherein each of the opposing contact arms includes a contact projection at the position where the pair of contact arms converge for contacting the blade fuse.

27. The blade fuse holder of claim 21, wherein the housing has an opening part proximate the cut-out for receiving the distal end of the blade fuse when the blade fuse is positioned in the housing.

28. The blade fuse holder of claim 21, wherein the pair of contacts are positioned in the housing such that each of the pairs of contact arms face each other.

29. The blade fuse holder of claim 21, further comprising a cover having a sealing ring, the cover being attached to the housing so that the cover protects the blade fuse.

30. The blade fuse holder of claim 21, further comprising tubular parts that extend from the housing for receiving the pair of contacts.

31. The blade fuse holder of claim 30, further comprising sealing members arranged on the tubular parts for sealing the housing.
